(19) United States
(12) Patent Application Publication
(10) Pub. No.: US 2015/0107065 A1
(43) Pub. Date: Apr. 23, 2015

(54) Device and Method for Tensioning and,or Securing a Material

(71) Applicant: John Paul Doering, The Villages, FL (US)

(72) Inventor: John Paul Doering, The Villages, FL (US)

(21) Appl. No.: 14/520,371

(22) Filed: Oct. 22, 2014

Related U.S. Application Data
(60) Provisional application No. 61/894,446, filed on Oct. 23, 2013.

(51) Int. Cl. B60P 7/08

(52) U.S. Cl. CPC B60P 7/0838
USPC 24/68 CD; 29/428

(57) ABSTRACT

An improved pliable planer material securing and or tensioning device and method. In one application the securing device and method has an interconnecting mesh with at least three connecting locations and at least one tightener where the force radiates in at least three directions simultaneously to secure and tension the pliable planer material around at least three wrapping locations. In one applications, it eliminates the need for rigid support bows, stops water from puddling, and eliminates loud sound vibration among other benefits.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

For a long time there has been a need across many industries to find a better way of tensioning and, or, securing a material. In regard to soft tops, there are many applications such as sport utility vehicle tops, pickup truck tonneau covers for pickup truck beds, cargo truck covers, bimini tops for boats, coverings for building, etc. There is also the need for a better way of tensioning and, or, securing material to the sides and bottoms of things, such as the sides of buildings, the bottoms of floors where construction projects are not complete and soft material is needed to catch falling debris, etc.

An excellent example from the automobile industry is the Jeep Wrangler. Experts in the field have consistently been trying to find better ways of tensioning and securing the soft tops to these vehicles. The bikini top or brief is one such soft top, which is very popular but suffers from many disadvantages.
a) Water collects in the center after it rains. Sometimes it can even be gallons of water if it is a big rainstorm. Once it collects in the top, it is very difficult to remove the water without getting wet or having the water enter the vehicle. Sometimes people take brooms or mops and try to push out the water from the top, which is a great annoyance, and usually ends with an incomplete removal of the water and a wet person.
b) The center of the soft top vibrates rapidly at high speeds, creating a noise that is so loud that people have to yell to be heard, and the soft top is destroyed quicker due to that wear and tear.
c) It comes loose very quickly after just being tightened.
d) Trying to tighten it is very troublesome and can be very dangerous. On the highway, the soft top comes loose quickly due to the fast speeds. When a person tries to reach in multiple locations to tighten it while driving an accident can occur. If they pull over on the side of the highway they are risking being injured. If they exit the highway to tighten the top, it is a great inconvenience.
e) There is a metal footman loop that the jeep wrangler manufacturer installs in the front of the vehicle, which allows the soft top to be attached. This additional piece of hardware costs money.
f) An inefficient and unstreamlined fit causes excess drag. This results in a reduced mileage per gallon.
g) When one of the many tightening locations is tightened, it tends to pull the material in the direction currently being tightened, and at the same time tends to skew the fabric and loosen the previously tightened locations.

FIG. 1-2 show one of the main problems with the soft material top for the Jeep Wrangler.

FIG. 1 shows a Jeep Wrangler. It has a top made of a soft material 5 that is above a passenger compartment 890. FIG. 2 shows the Jeep Wrangler after it has rained. The soft material 5 that is above the passenger compartment 890 has collected gallons of water. The heavy weight of the water is causing the soft material 5 to bulge into the passenger compartment 890.

U.S. Pat. No. 8,240,743 shows a rigid bar, with a bow shape to it, that is mounted on the Jeep Wrangler support bars, and the soft top lays on top of it. It forces the soft top up so that the water is forced to roll off, and also it is supposed to help tension the center, to help stop it from flapping violently and making a loud noise when driving at high speeds. There are many drawbacks to this solution. Most of them will be listed below and included with the disadvantages of the next product.

SFK Manufacturing, LLC produced the Top Prop™ in order to try and solve these problems as well. This product is in demand, and has been sold by Quadratec, for many years. Quadratec is one of the best know Jeep product and accessory retailers. In their advertisement on the Quadratec website, they address several of the problems that were previously mentioned: “Do you have to yell to your passenger just to be heard? Or crank up your radio and then still have trouble hearing it? How many times have you gone out to your Jeep® and discovered that your soft top has literally collected gallons of water? These Props hold your top up over the seats and force water to roll off the top rather than collect on it. It makes driving quieter since it prevents the top from flapping in the breeze, and your top will last longer due to less wear and tear. It's very simple to install.” There are several major problems with this solution.
a) The TopProp™ is very expensive. As of Apr. 25, 2012, the TopProp had a retail price from Quadratec of $39.99, which is more than the actual soft top itself costs.
b) It also has to be installed.
c) For some models such as the 2003-2006 models the installation instructions call for cutting away some of the factory installed padding.
d) Hose clamps or screws must be used for installation. The hose clamps are quite unsightly; and if the screws are used, then holes must be drilled into the vehicle first.
e) There are also problems with splinters with the equipment, as the instruction manual says, “Wear gloves while handling the fiberglass slat to prevent yourself from getting any splinters in your hands.”
f) It looks very unsightly and unstreamlined.
g) It adds an additional piece of hardware that must be stored away when trying to take off the soft top.
h) If the soft top is taken off, and the Top Prop is left installed, then there is a serious safety risk to others if the item is blown off the vehicle; this could lead to serious harm to others, including those in the Jeep.

Another company, Rugged Ridge, also tried to solve some of these problems. They created the Acoustic Brief, which also retails through Quadratec. Their advertisement says, “This unique design drastically reduces road noise within the cab of your Jeep. This top has been lined with tightly woven acoustic padded inserts to absorb outside noise. You can finally listen to your radio while enjoying open air driving.” There are several major problems with this solution.
a) A lot of very thick acoustic material is sewn into the top, which makes it very expensive. It was listed at $129.99 from Quadratec on Apr. 25, 2012.
b) The bulkiness of the top causes it to not look very good.
c) The bulkiness also makes it difficult to store away in the vehicle when it is taken off for open air driving.
d) It collects water when it rains.

Jeep Aid sells a product on their website (http://www.jeeptopaid.homestead.com) which is a metal bar that is installed using Velcro straps. There are several major problems with this solution.
a) Because it is at the top of the vehicle and only installed using Velcro, it has a potential to fly out of the vehicle and severely injure someone.
b) It is also quite unsightly.

Just as there has been a need for a superior method of securing material tops over passengers, there is also a need for a superior method of securing material over the backs of open bed vehicles such as jeeps, pickup trucks, and large cargo trucks. The experts who work in these areas have the same problems to face with water collecting and lots of noise being made by the poor securing devices and methods currently used in the art.

Skid Row also makes the Offroad Tonno Prop™. It is sold by Quadratec and is designed for the back cargo area of the Jeep, where items are stored. The advertisement on the Quadratec website says, “Skid Row Offroad's Tonno Prop supports your deck cover over the rear cargo area and forces water to roll off the cover rather than collect in it. Makes driving a quieter experience since the material is prevented from flapping in the breeze. Very simple to install and can be used with virtually any tonneau cover.” There are some major problems with this solution.
a) It is very expensive. The Quadratec website on Apr. 25, 2012 had it listed for $44.99 which is almost as much as some tonneau covers cost.
b) It requires installing hardware.
c) It is unsightly.
d) There is always the risk of the item being blown from the vehicle and causing injury.

There are many other soft tops that have this same type of problem. They won't all be listed. Here, however, are just a few of the many patent examples that show the experts in the field teaching to use rigid support structures, many times referred to as bows, in order to support and, or, tension the soft vehicle tops used to cover the cargo areas of some types of vehicles: U.S. Pat. No. 6,948,761, U.S. Pat. No. 7,334,830, U.S. Pat. No. 7,905,536, U.S. Pat. No. 6,793,273, US20090159592.

It has also been found that in the boating industry the experts teach using rigid supports and bows in order to secure and or tension the fabric tops that cover passengers. Here are just a few of the many patent examples that show the experts in the field teaching to use rigid support structures, many times referred to as bows, in order to support and, or, tension the soft tops used to cover passengers and other items in a boat: U.S. Pat. No. 6,439,150, U.S. Pat. No. 6,637,364.

Other industries also teach the use of rigid support structures for things such as buildings, tents, pavilions, construction project, etc. Here are just a few of the many patent examples that show the experts in the field teaching to use rigid support structures, many times referred to as bows, in order to support and, or, tension the soft tops: U.S. Pat. No. 5,441,069, U.S. Pat. No. 7,146,995, U.S. Pat. No. 7,219,681, U.S. Pat. No. 7,380,562, US20060249193.

It has also been found that the experts in the field also have a very inadequate way of attaching and tensioning soft material to the sides and bottoms of things. This seems to be true in many areas, but especially in the area of pavilions, canopies, tents, etc. Currently buttons, hook and loop fasteners, bungee cords and other methods are used, but they are inadequate in that the sides and bottoms are loosened very easily, especially when the wind speeds are high, which is the main time that you really want a shelter to be securely attached and tensioned.

### ADVANTAGES

Below are listed some of the different advantages of some of the different embodiments. The advantages sometimes differ based on the different embodiments.
a) There is no need for any rigid support structures or rigid bows to be placed under the material. The material top is secured so tightly that in a rainstorm the water rolls right off of the top and does not collect on it. So there is no need to use a broom to try and remove the water after it rains.
b) An unexpected result is that at high speed driving, the top is so tight and secure, that almost no noise is made. It is easy to talk to your passengers without yelling. And there is no need for sewing in additional acoustic material like under the prior art in order to reduce the noise. This saves a lot of money and is very convenient.
c) The top stays tight for a very long time. It is not loosened quickly like under the prior art. Even when driving at high speeds. It stays tight and secure for a very long time, very infrequently needing to be retightened.
d) The soft top lasts longer because it is not destroyed from wear and tear from the top vibrating and flapping violently in the wind.
e) Tightening it is very easy and safe.
f) The number of securing locations is greatly reduced. In the Jeep Wrangler example the number of securing locations in the prior art was 7. With this new innovation, the number of securing locations is reduced to two, yet it provides a far superior result.
g) The number of tightening locations is greatly reduced. In the Jeep Wrangler example, the number of tightening locations in the prior art was five. With this new innovation, the number of tightening localons is reduced to one, yet it provides a far superior result.
h) It is much less inexpensive compared to the prior art solutions. In the prior Art Jeep Wrangler Example, using a rigid bow to eliminate the water and loud noise, cost $44.99. Yet with the new innovation, this cost is completely eliminated. When the new innovation is incorporated into a soft top, the costs are generally a wash, as some new buckles are added, but many Velcro straps and the costs associated with sewing them in are eliminated, and the length of the rear strap is reduced. In effect, it costs the about the same price to the manufacturer to create the soft top as before, but now, it will not collect water and will not make loud noise. This saves the customer about $44.99.
i) There is no requirement for cutting away factory installed padding, like under some of the examples of the prior art.
j) There are no requirements about wearing gloves to prevent getting any splinters in your hands.
k) When it is time to take the top off for open air driving, there is no need to stow away props and bows since there are none. And there is no more danger that a person could forget and leave a prop or bow on and result in it being blown out of the vehicle and injuring someone, or blowing into the rear passenger compartment and hitting a passenger.
l) The tight, streamlined, and aerodynamic fit reduces drag. This results in better gas mileage per gallon.
m) The metal footman loop that the jeep wrangler manufacturer installs in the front of the vehicle is not needed. So the manufacturers have one less reason to pay to have that item installed on their vehicles. This can save them money.
e) Because it stays extremely tight for a very long time, with very little need to retighten it, it makes driving much safer. The driver is not tempted when driving to try and reach multiple, difficult to reach tightening locations like under the prior art. Instead it very seldom needs tightening. And if it does, the driver can simply reach their right arm up and pull a single, easy to reach tightening strap. The force immediately radiates throughout the entire top, making it a very quick, safe, and easy way of tightening. In the prior art many times, the driver would have to find a place to exit the freeway, or pull over on a dangerous side of the road, and get out and walk around the vehicle, tightening many locations. Now this dangerous and time-consuming process is no longer needed.
f) No skewing of the top occurs when tightening, since the force radiates to all connecting locations at the same time. This is unlike in the prior art, where tightening one location skews the material in that direction, causing the other locations that were previously tightened to become loose. This was one of several unexpected results.
g) A synergistic effect takes place from a change in angle of the tightening straps. In the prior art they were positioned to tighten straight across in the cross car direction, or directly back. With the new innovation, some of the connecting locations are at an angle. This angle causes the force to simultaneously radiate the tensioning force both laterally and rearward at the exact same time. Another major synergistic effect takes place by interconnecting the side straps with the rear straps. The tightening of a single tightening location radiates the force in at least three directions all at once, pulling out any of the areas that have slack first, and pulling the central part of the top in multiple directions at once, stopping the skewing process that took place in the tightening process of the prior art, and making for an extremely tight, efficient and effective fit.

### DRAWINGS—FIGURES

FIG. 1 shows a Jeep Wrangler. It has a top made of a material. The material top covers a passenger compartment.

FIG. 2 shows the Jeep Wrangler after it has rained. The material that is above the passenger compartment has collected gallons of water. The heavy weight of the water is causing the material to bulge into the passenger compartment.

FIG. 3 shows a first embodiment.

FIG. 4-6 show an interconnecting mesh, which is part of the first embodiment, and in another situation it is the entire embodiment.

FIG. 7-15 how to make an embodiment.

FIG. 16 is a rear view from below of a passenger compartment of a motor vehicle.

FIG. 17 is a side view of the front top section of a motor vehicle with the material inserted in a front securing location.

FIG. 18 is a rear view from below of an embodiment resting on the passenger compartment of a motor vehicle.

FIG. 19 is a strap adjuster.

FIG. 20 is a rear view from below of an embodiment in the fully operational position.

FIG. 21-22 show a cargo truck with the prior art rigid support structures and the prior art top material.

FIG. 23 shows a cargo truck with an embodiment in the operable position.

FIG. 24 shows a pickup truck bed with wrapping locations.

FIG. 25-35 show alternative embodiments.

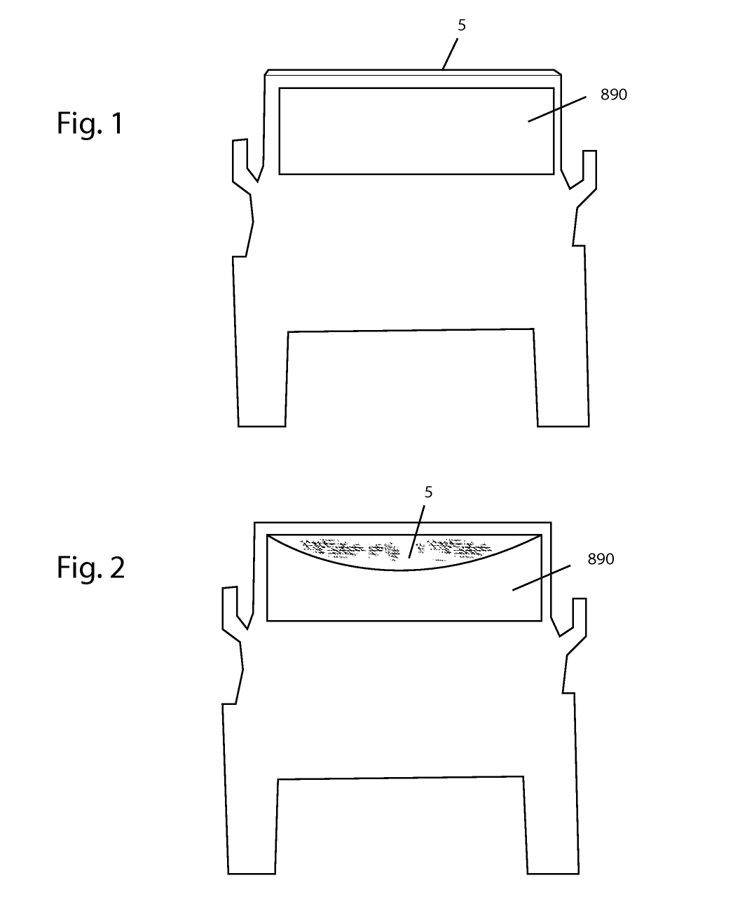

### REFERENCE NUMBERS

5 material
15 prior art soft vehicle top
18 connecting location
20 first connecting location
30 second connecting location
40 third connecting location
41 first connecting member
42 second connecting member
43 third connecting member
105 single-bar slide
110 first single-bar slide
120 second single-bar slide
130 third single-bar slide
135 fourth single-bar slide
140 strap adjuster
145 metal ratchet
148 cord tightener
150 carabineer
160 box stitch
190 back end
200 front end
220 rear segment
230 front segment
240 loose end
260 left side edge
270 right side edge
272 front edge
274 rear edge
300 front retainer lip
315 front securing location
318 first wrapping location
310 hooks
320 second wrapping location
330 third wrapping location
350 footman loop
360 windshield
410 prior art hook and loop fasteners
420 prior art rear strap
500 windshield retainer
610 cargo truck
815 wrapping locations
880 prior art rigid support structure
890 passenger compartment
900 metal ring
905 ring
910 exit location
950 pickup truck bed

### DETAILED DESCRIPTION

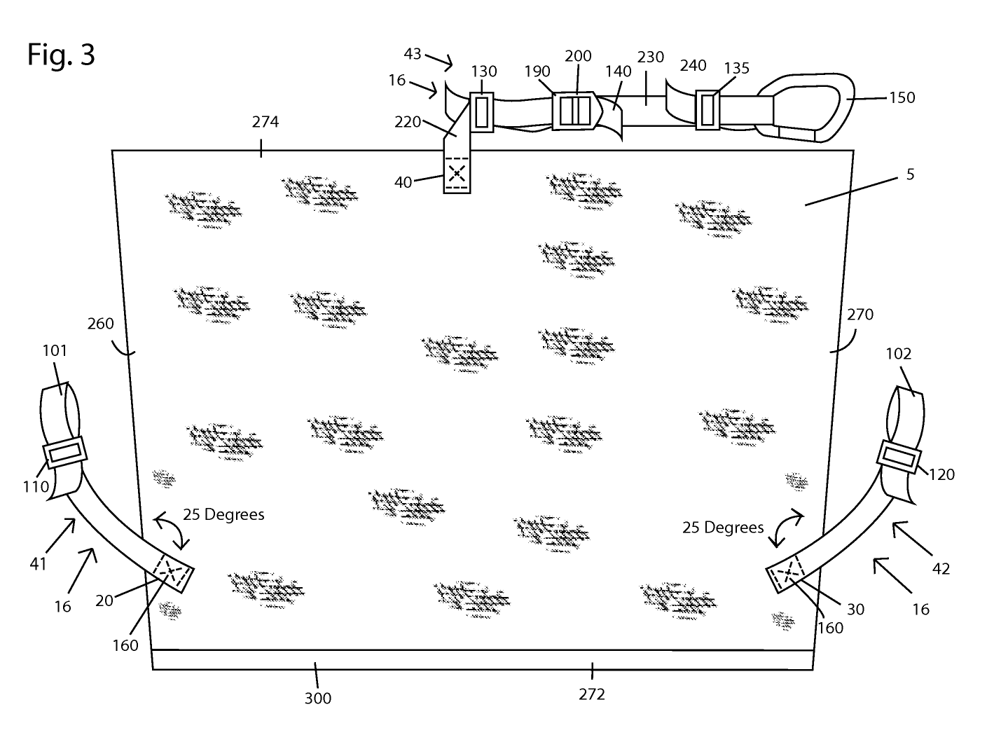

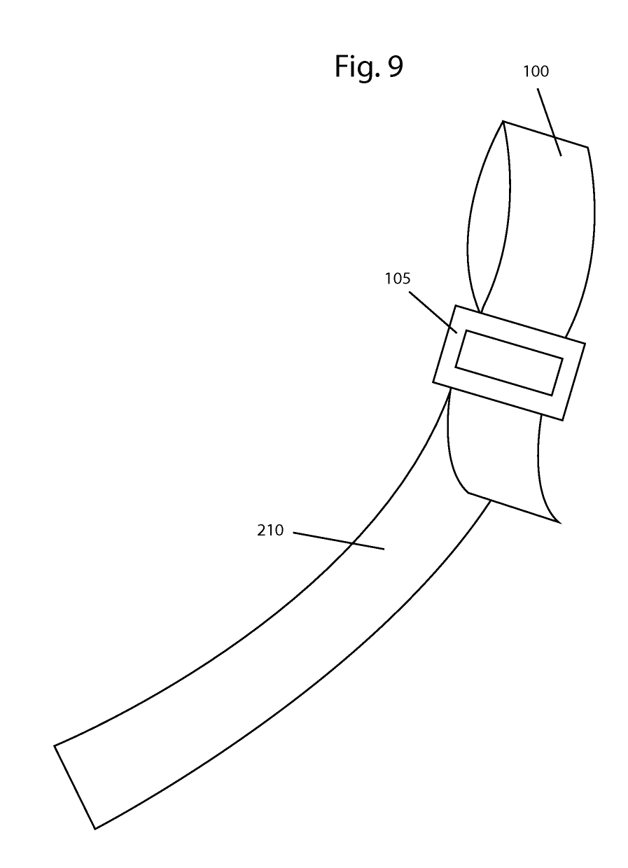

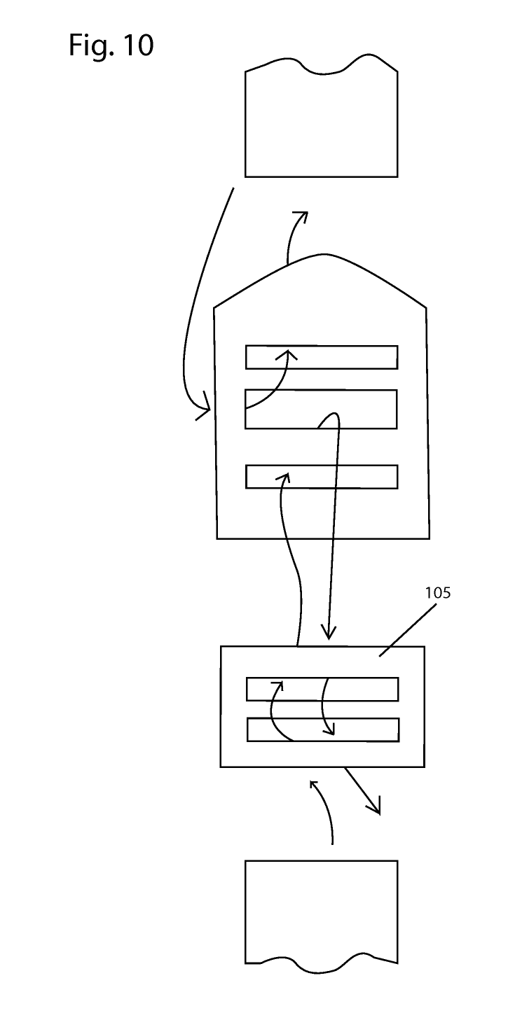

### A First Embodiment—FIGS. 3-15

FIG. 3 shows a first embodiment. I contemplate in this embodiment that an interconnecting mesh 16 be made of a first connecting member 41, a second connecting member 42, a third connecting member 43. I contemplate that at the end of the first connecting member 41 is a first connecting location 20. I contemplate that at the end of the second connecting member 42 is a second connecting location 30. I contemplate that at the end of the third connecting member 43 is a third connecting location 40.

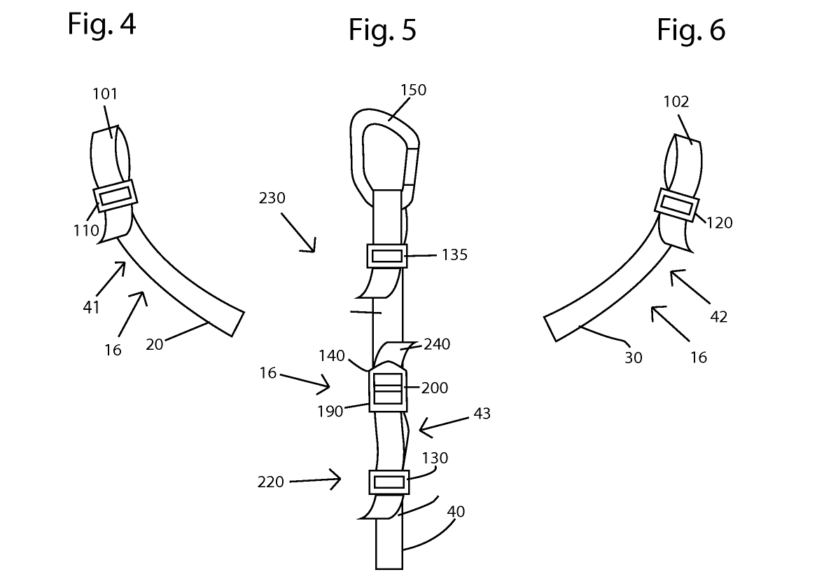

FIG. 4 shows the first connecting member 41. In this embodiment, I contemplate that the first connecting member 41 is made from a one inch wide, four and a half foot long nylon strap, but other materials are suitable such as rope, metal cable, twine, etc. I contemplate in this embodiment that one end of the first connecting member 41 has a first loop 101 that is held in place by a first single-bar slide 110.

FIG. 6 shows the second connecting member 42. In this embodiment, I contemplate that the second connecting member 42 is made of a one inch wide, four and a half foot long nylon strap, but other materials are suitable such as rope, metal cable, twine, etc. I contemplate in this embodiment that one end of the second connecting member 42 has a second loop 102 that is held in place by a second single-bar slide 120.

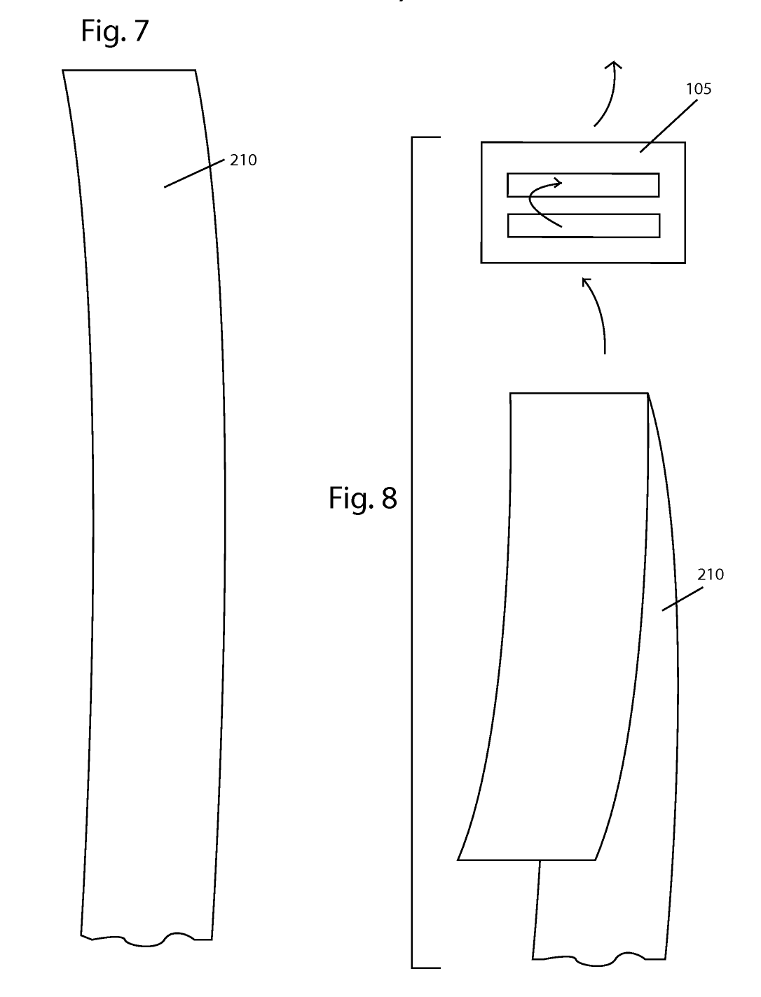

To make the first loop 101 and the second loop 102 refer to FIG. 7-9. Take one end of a nylon strap 210 and bring it back upon itself. Thread the nylon strap 210 through a single-bar slide 105. I contemplate in this embodiment that the single-bar slide 105 holds a loop 100 in place, but other ways of holding the loop 100 in place are fine such as sewing, clamping, riveting, tying, etc.

FIG. 5 shows the third connecting member 43, and a strap adjuster 140.

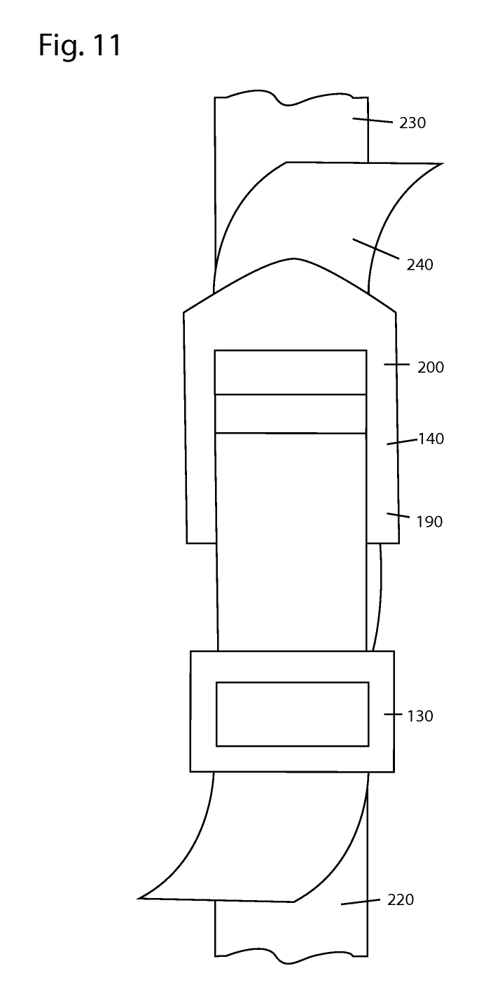

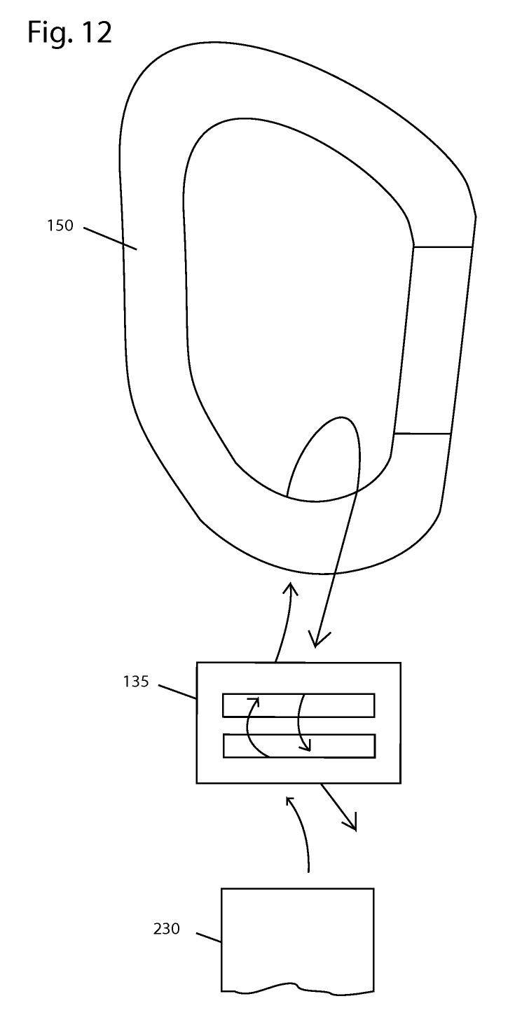

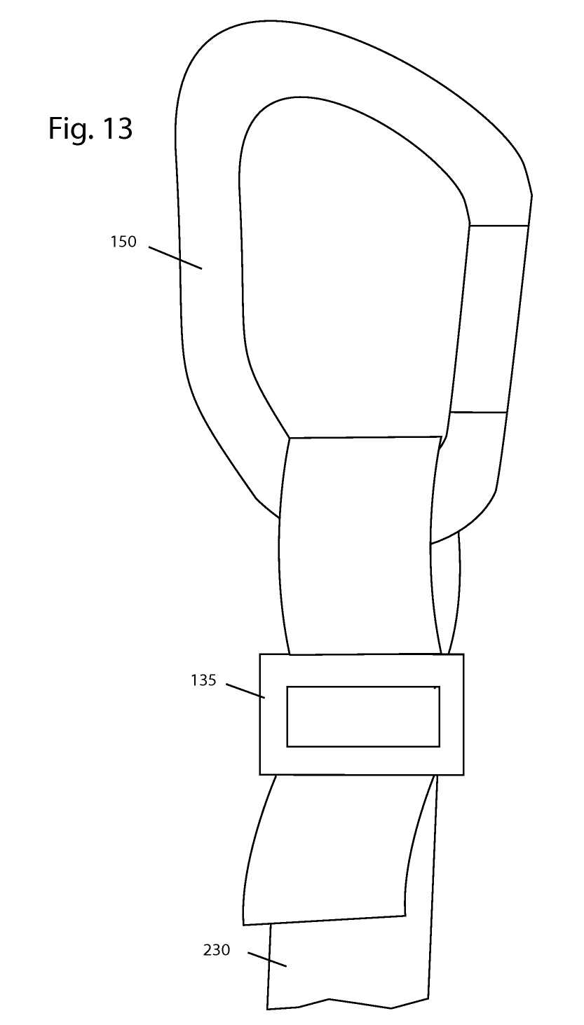

FIG. 10-13 show how to make the third connecting member 43. In this embodiment I contemplate that the third connecting member 43 consists of a rear segment 220, a front segment 230, a third single-bar slide 130, a fourth single-bar slide 135, the strap adjuster 140, and a carabineer 150. In this embodiment, I contemplate that the rear segment 220 should be made out of a one inch wide, one and a half foot long nylon strap. In FIG. 10-11, take one end of the rear segment 220 and thread it through the third single-bar slide 130 and then through the back end 190 of the strap adjuster 140 so it comes back upon itself, and run it back through the third single-bar slide 130. In this embodiment, I contemplate that the strap adjuster 140 is used to tighten the interconnecting mesh 16 of FIG. 4-6, [symbol] In this embodiment, I contemplate that the front segment 230 should be made out of a one inch wide, four foot long nylon strap. In FIG. 10-11, run one end of the front segment 230 through the front end 200 of the strap adjuster 140. Leave several inches of loose end 240 hanging out of the strap adjuster 140. In FIG. 12-13, run the other end of the front segment 230 through the fourth single-bar slide 135 and then through the carabineer 150, and then bring it back through the fourth single-bar slide 135.

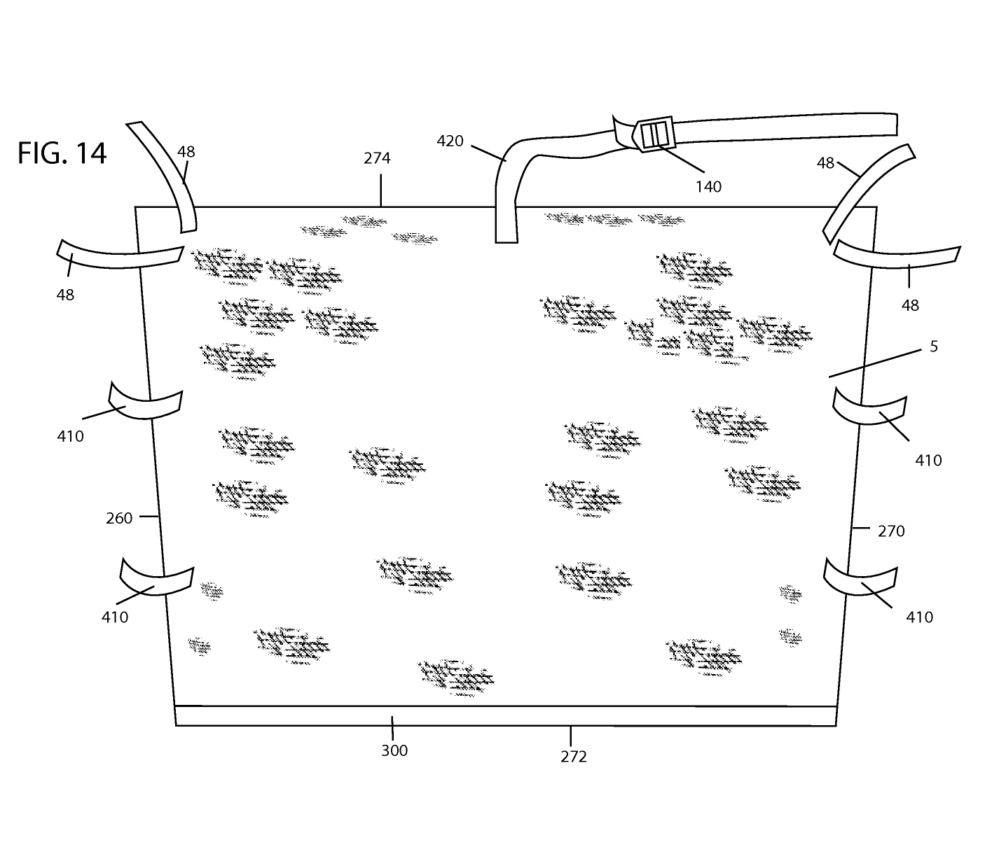

FIG. 14 is a prior art soft vehicle top. We will modify it to obtain what we need for this embodiment. Knowing the exact size of the material 5 is not necessary, since it arrives already cut to size by the manufacturer. In this case, order a soft bikini top from Bestop for a 1994 Jeep Wrangler YJ. There is generally a left side edge 260, a right side edge 270, a front edge 272, a rear edge 274, a front retainer lip 300, prior art hook and loop fasteners 410, prior art corner straps 48, and a prior art rear strap 420. Use a pair of scissors 80 and cut off the prior art hook and loop fasteners 410, the prior art corner straps 48, and the prior art rear strap 420.

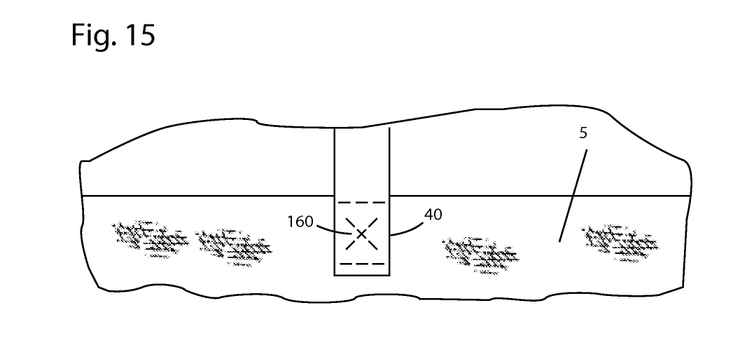

FIG. 15 is a close up of a box stitch 160. I contemplate that in this embodiment several box stitches be used to secure the interconnecting mesh 16 shown in FIG. 4-6 to the material 5 in FIG. 14. In all of the cases where a box stitch 160 is used, other ways of attaching can be used instead such as sewing, binding, stapling, tying, gluing, sliding attachments, fixed attachments, semi fixed attachments, etc.

In FIG. 3, attach the first connecting location 20, in this case using a box stitch 160, to the left side edge 260, roughly four inches from the front edge 272 and at a 25 degree angle to the left side edge 260. Attach the second connecting location 30, in this case using a box stitch 160, to the right side edge 270, roughly four inches from the front edge 272 and at a 25 degree angle to the right side edge 270. Attach the third connecting location 40, in this case using a box stitch 160, to the rear edge 274. The front retainer lip 300 comes already attached to the front edge 272 when you purchase the bikini top from Bestop. This is nice because you don't have to create your own way of attaching the front edge 272.

I contemplate in this embodiment that the first connecting location 20 is attached to the left side edge 260, but other locations are fine. It does not have to be attached to the edge, but can be attached away from the edge, closer to the center, and in other locations. And I contemplate in this embodiment that the first connecting location 20 be attached about 4 inches from the front connecting edge 272 and at a 25 degree angle 276, but other locations and angles are fine. It also does not have to be attached at an angle. I contemplate in this embodiment that the second connecting location 30 is attached to the right side edge 270, but other locations are fine. I contemplate in this embodiment that the second connecting location 30 is attached about 4 inches from the front edge 272 and at a 25 degree angle, but other locations and angles are fine. I contemplate in this embodiment that the third connecting location 40, be attached midway between the left side edge 260 and the right side edge 270, but other locations are fine.

In all of the examples where the interconnecting mesh 16 is attached to the material 5, the exact location can vary. The connections can be in different locations along the edges or even not on the edges at all but at corners or closer to the center of the material 5 and not on the edges at all.

I contemplate that the interconnecting mesh 16 can be formed in many ways. It does not have to consist of separate members. It could be of one single material. Or it could consist of a multitude of members broken and joined in many different ways. The interconnecting mesh 16 could be formed in many other ways as well.

I contemplate that in all of the locations where the mesh is made using nylon strap, that anything could be used in place of the nylon strap such as rope, metal cable, twine, etc. I contemplate in this embodiment that there are loops 100 for making interconnections between the members that make up the interconnecting mesh 16, but the members can be interconnected in any way such as stitching, gluing, tying, binding, bolting, riveting, etc. Loops are not necessary.

I contemplate in this embodiment that the loops 100 are held in place with single-bar slides, but if loops 100 are used, then there are infinite ways to hold the loops in place such as stitching, bolting, gluing, binding, etc.

I contemplate in this embodiment that the carabineer 150 is used to interconnect the other connecting members together. However, a carabineer 150 is not necessary. The connecting members could be interconnected in many ways such as sewing, binding, stapling, gluing, etc. They could also be cut from a single material, making it unnecessary to interconnect them, as they would already be interconnected.

I contemplate in this embodiment that a strap adjuster is used to tighten the interconnecting mesh 16. However, any other method and device for tightening can be used. Also, the material that the mesh is made of can determine the device used for tightening. For example, a rope-tightening device would be needed for rope. A cable-tightening device would be needed for a cable. A rigid tightening device might be needed for rigid materials, etc. Other types of materials and tightening devices and methods can be used. The device for tightening can be located anywhere on the interconnecting mesh 16.

I contemplate that the connecting locations can be attached in any way possible. For example, sewing, binding, gluing, riveting, sliding through a loop, Velcro, and all other possible ways. The soft material 5 and the connecting locations could also be formed through a single uncut material, essentially not requiring them to be connected, as they would be connected already through their seamless manufacturing process.

I contemplate in this embodiment that the front edge 272 is attached using a retainer lip 300, but any way is fine for attaching the front edge 272. It can be attached by bolting, tying, taping, gluing, stapling, strapping, and, binding, etc. Also, I contemplate that front edge 272 does not have to be attached in its entirety. It could be attached in sections, or at a single location.

I contemplate that the interconnecting mesh 16 can be made of more or less than three members. Other embodiments will show that more and less than three members will work.

I contemplate that at least three connecting locations are used, but more than three can be used. They can be interconnected in an infinite amount of ways. The three connecting locations are all that is required to solve the two most major problems of the prior art. Those problems are that water collects in the center of the material 5 when it rains; and when the wind speed is high, the soft material loosens quickly and makes an extremely loud sound. Therefore, it is important to know that when only three connecting locations are used, other parts of the soft material may dangle and flap in the wind. However, the main objective is accomplished, and, that is, that the material 5 is tightened so well and securely that water will not collect in the center and the center will not vibrate quickly in the wind. Once this main problem of the prior art is solved, the other peripheral locations are not of concern. For example, other corners and edges can easily be attached using any methods available under the prior art. For example, the corner straps can be left on and can be used to tie down the corners. However, they are not needed for eliminating the problem of the water collecting in the middle or stopping the center of the top from vibrating rapidly. They look more aesthetically pleasing to tie them down, and they prevent water from entering the vehicle at the corners. In addition, they could be interconnected with the mesh, and if interconnected, would simply add new connecting locations to the mesh. This would still fall within the scope, as it still meets the requirement of at least three connecting locations being used. In this case, more connecting locations are added.

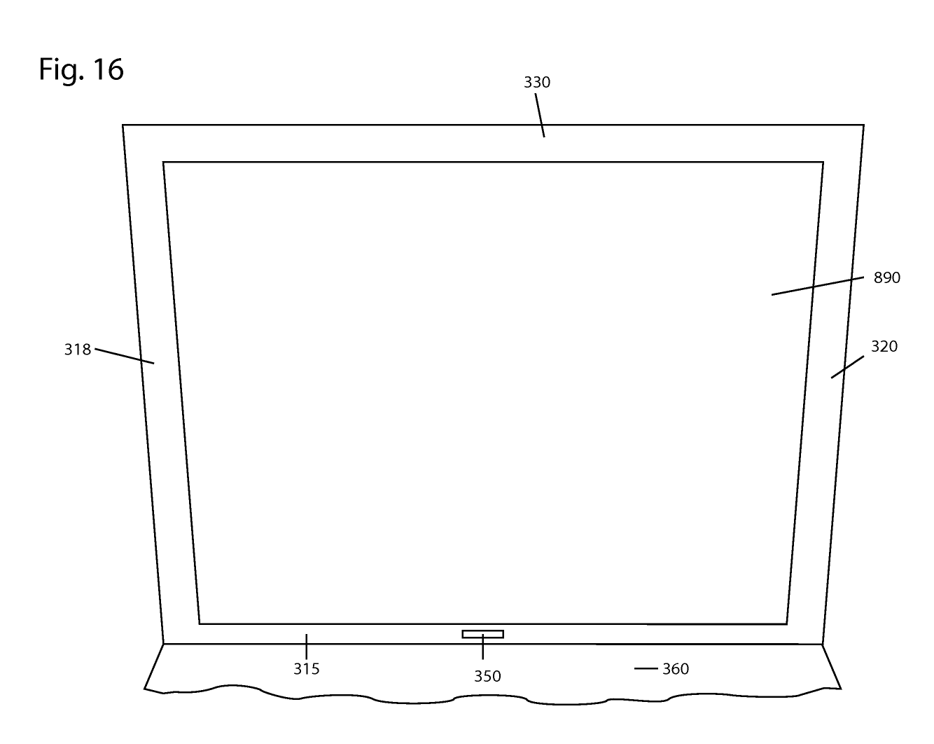

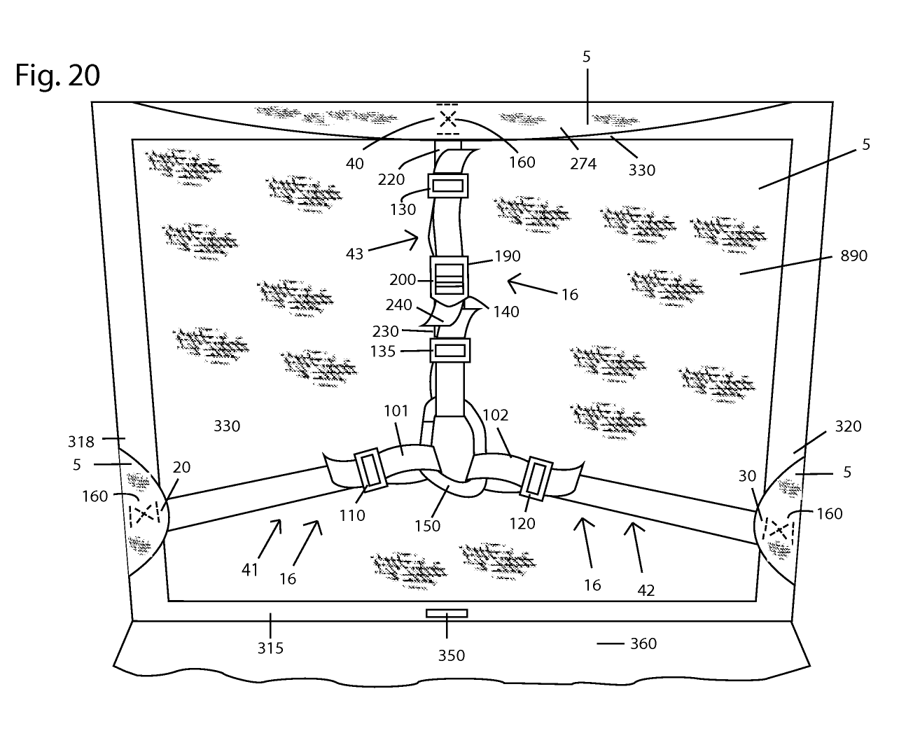

### The First Embodiment Operation—FIG. 16-20

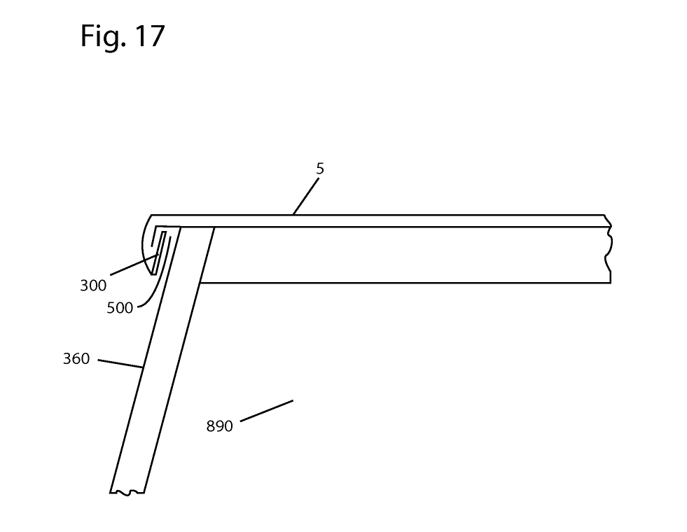

FIG. 16 is not part of this embodiment, but will be used to show how to operate this embodiment. FIG. 16 shows a rear view from below looking up at a passenger compartment 890 of a motor vehicle. In this case the motor vehicle is a 1994 Jeep Wrangler YJ. It has a front securing location 315, a first wrapping location 318, a second wrapping location 320, a third wrapping location 330, a footman loop 350, and a windshield 360. Also, FIG. 17 shows a windshield retainer 500 that is also not part of this embodiment, but is part of the motor vehicle and is used in the operation of this embodiment. Though none of these items are part of this embodiment, they will be used to show how this embodiment can work.

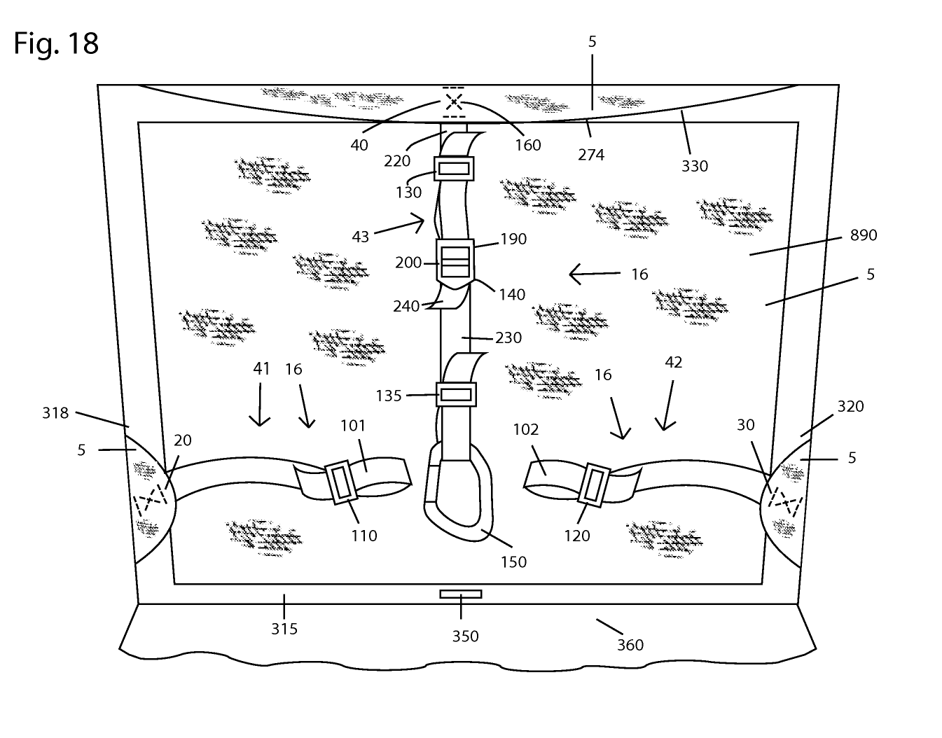

In FIG. 18, drape the material 5 over the passenger compartment 890.

In FIG. 17, insert the front retainer lip 300 into the windshield retainer 500.

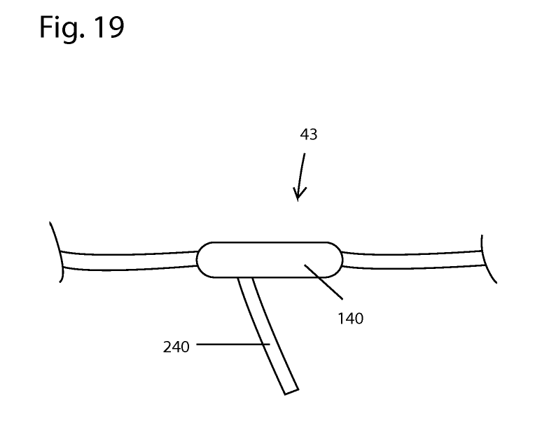

In FIG. 18, wrap the first connecting member 41 around the first wrapping location 318. Wrap the second connecting member 42 around the second wrapping location 320. Wrap the third connecting member 43 around the third wrapping location 330. Bring the first loop 101 of the first connecting member 41 and the second loop 102 of the second connecting member 42 together and put the carabineer 150 through them both. Pull any slack out of the first connecting member 41 by adjusting it through the first single-bar slide 110. Pull any slack out of the second connecting member 42 by adjusting it through the second single-bar slide 120. Tighten the strap adjuster 140 by pulling on the loose end 240 as in FIG. 19. When you do this, the force will radiate through the interconnecting mesh 16 simultaneously to the first connecting location 20, the second connecting location 30, and the third connecting location 40. This pulls the material 5 in an even manner, preventing any skewing of the top. It pulls out the slack in the middle of the material 5 so tightly and efficiently that no water will collect on it and there is no more need for any prior art rigid support structures to hold up the material 5.

### A Second Embodiment—FIG. 4-6

A second embodiment is similar to the first embodiment; however, it only consists of what is shown if FIG. 4-6. It has in general at least three connecting locations which are a first connecting location 20, a second connecting location 30, and a third connection location 40. There is an interconnecting mesh 16. I contemplate that in this embodiment that at least one strap adjuster 140 is attached to at least one location on the interconnecting mesh 16. However the strap adjuster can be anything that can be used to tighten the interconnecting mesh 16 such as a ratcheting device, ladderlock buckle, cord tightener, rope tightener, strap tightener, etc. The tightening locations are attached to a material that needs to be secured and, or, tensioned. When the strap adjuster is pulled tight, the force radiates throughout the interconnecting mesh 16. Because the interconnecting mesh 16 is interconnected with itself and to the first connecting location 20, the second connecting location 30, and the third connecting location 40, the force automatically radiates towards any location that has slack, resulting in a very thorough and simultaneous distribution of tensioning force. The simultaneous distribution of the tensioning force is extremely important. Under the prior art, when a tightening force is applied to a single location, it causes a skewed pulling on the material, causing other locations that were previously tightened to come loose.

### Alternative Embodiments

There are other ways that those skilled in the art can come up with additional embodiments. Below are some alternative embodiments, but there are others as well.

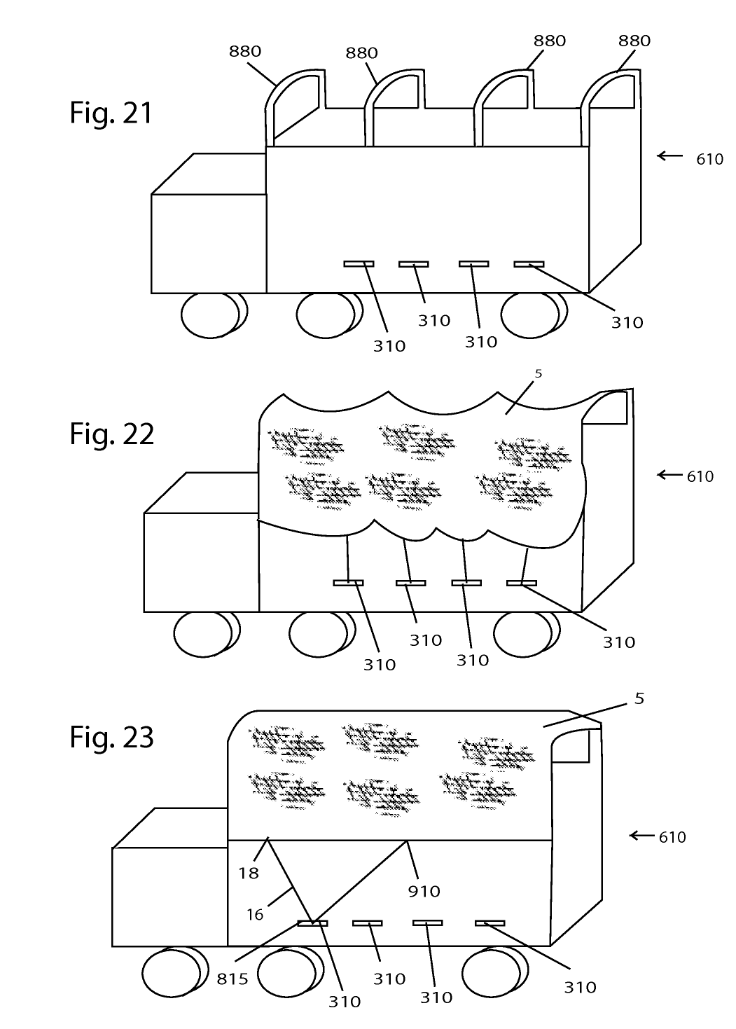

FIG. 21 shows a cargo truck 610 of a type that is very common is Asia and South America. In the prior art, it has several prior art rigid support structures 880. In most cases these prior art rigid support structures 880 are made out of metal.

FIG. 22 is an example of the prior art where the material 5 is draped over the prior art rigid support structures 880 to keep rain from collecting in the middle of the soft material 5. Also, notice how there are a multitude of hooks 310 that are used for tying down the material 5. Notice the wavy, unstreamlined way it is pulled over and settles upon the rigid support structures.

FIG. 23 shows an embodiment. Since there are many hooks 310 on the side of the cargo truck 610, they can be used as wrapping locations 815. Notice the streamlined look of this embodiment. Also notice the member that connects at the connecting location 18 and then wraps around the wrapping location 815 goes off and under the soft material 5 and out of sight, where it will interconnect with the interconnecting mesh.

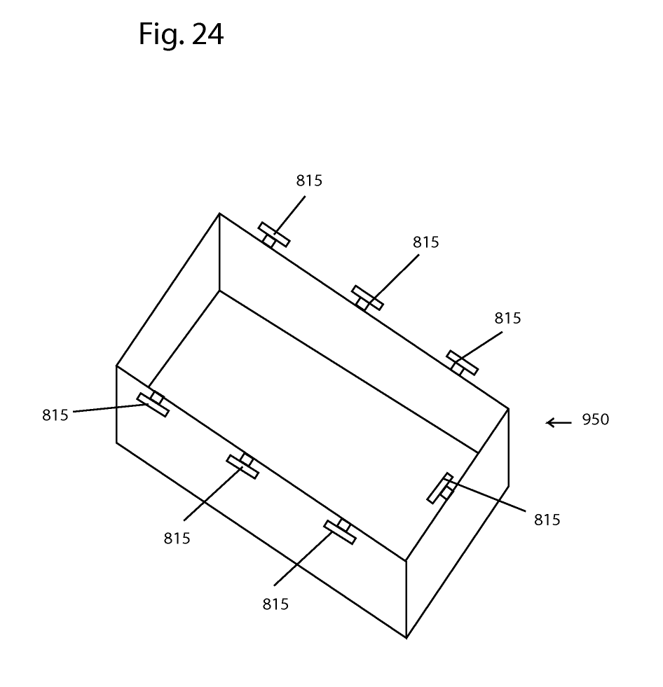

FIG. 24 shows a pickup truck bed 950. It shows that there are many potential wrapping locations 815.

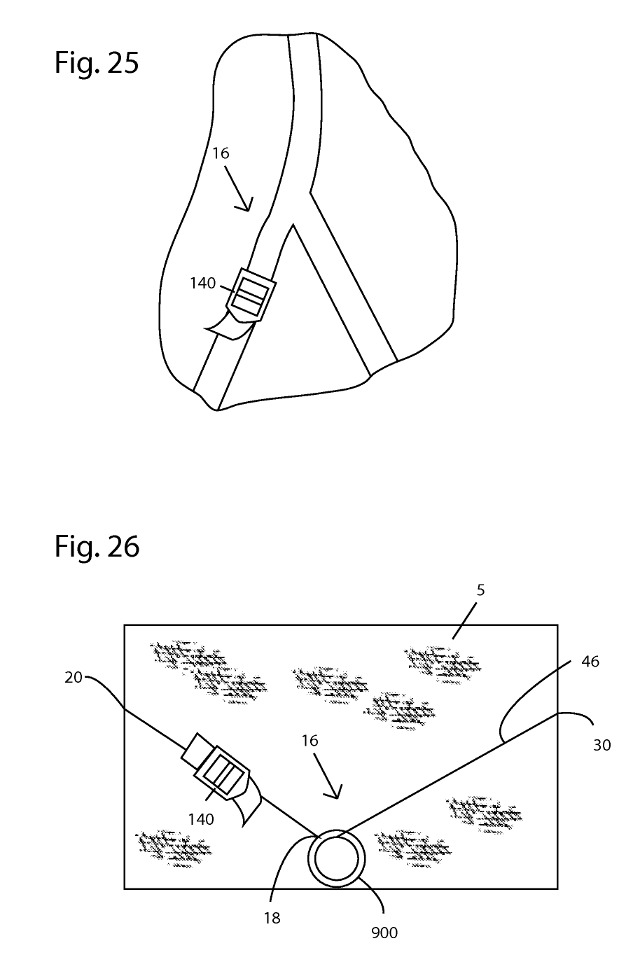

FIG. 25 shows an embodiment where the interconnecting mesh 16 consists of a single piece of material that is cut from a single piece of material. There is no need to interconnect the connecting members, as they are all interconnected since they were formed interconnected when the piece was cut from a single piece of material. This further makes and shows the point that the interconnecting mesh 16 can be broken into multitudes of segments, or be of one piece. The superior functioning over the prior art still works no matter how many segments or pieces the connecting members are, or are not, broken into. A strap adjuster 140 is attached at any location on the interconnecting mesh 16. The strap adjuster can be any device for tightening, such as a rope tightener, chord tightener, strap tightener, or any type of material tightener, etc.

FIG. 26 shows an embodiment where a connecting location 18 slides through a metal ring 900. But it could slide through anything and in any manner, such as through a loop of material, maybe a loop of nylon, etc. It is important to note that it is attached, even though it is not a fixed attachment, but rather a sliding attachment. This demonstrates that all connecting locations in all embodiments can be attached in many ways, such as direct attachment, sliding attachment, semi-sliding attachment, etc. In all embodiments the connecting location 18 could also be considered to be where the metal ring 900 attaches to the material 5, and the metal ring 5 itself could be considered to be part of the interconnecting mesh 16. The metal ring could be anything, such as a loop, grommet, hole, etc. In all embodiments the connecting location 18 could be considered anywhere on the connecting member 46 that touches the metal ring 900 or other device that helps make a connecting location. The connecting locations help connect the interconnecting mesh 16 to the material 5.

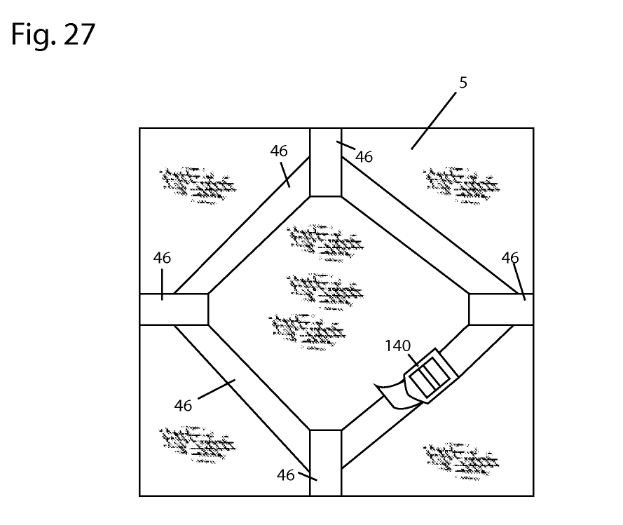

FIG. 27 shows an embodiment where there are five connecting members 46. The connecting member that has the strap adjuster 140 on it runs through the other connecting members 46. It slides through them. When the strap adjuster 140 is tightened, the connecting member 46 that it is attached to becomes smaller, pulling in and tightening all of the other connecting members 46 simultaneously. The interconnectedness allows any side that has slack to be pulled out first, providing an evening tensioning force throughout the entire pliable planer material, or soft material 5.

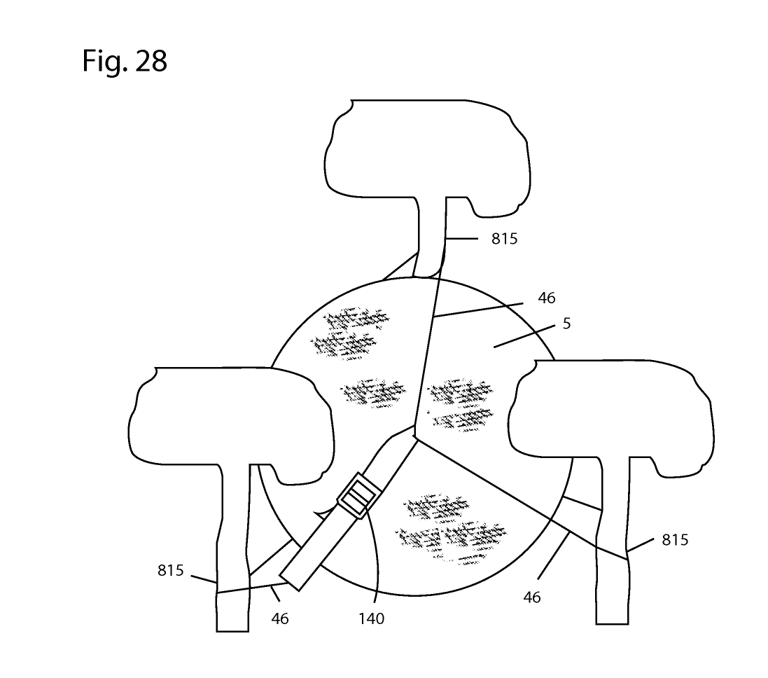

FIG. 28 shows an embodiment where there are three wrapping locations 815. In this case the wrapping locations 815 are trees. FIG. 28 also shows the embodiment in an inverted position. This helps demonstrate that all embodiments can be used inverted, or at any angle. FIG. 28 also demonstrates that in all embodiments, the shape of the material 5 does not matter. It can be round, or have any number of sides, and any type of shape.

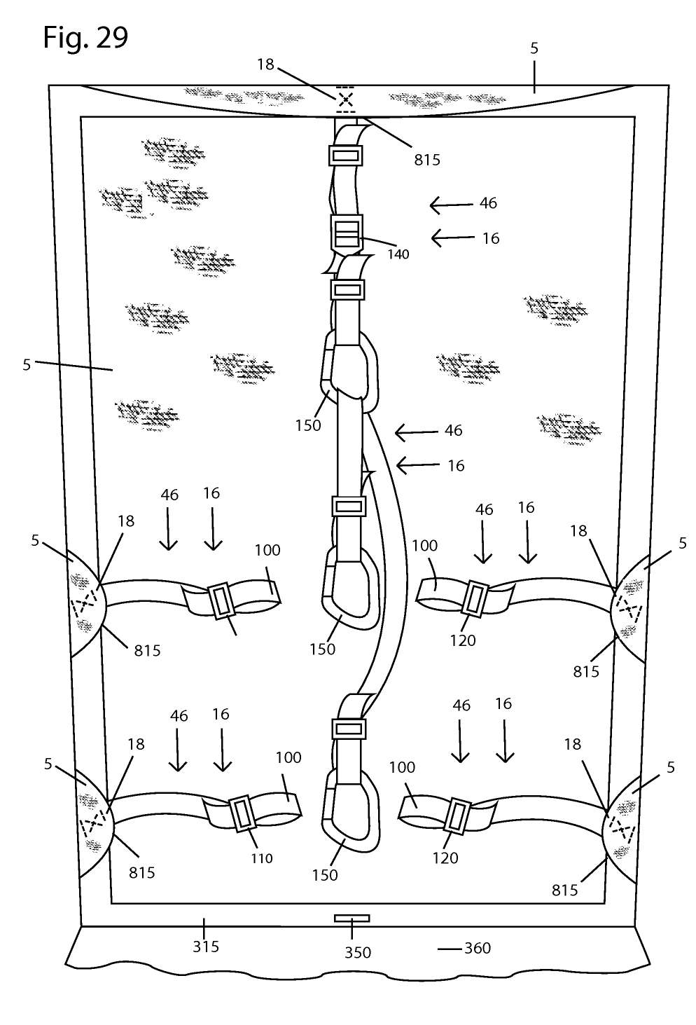

FIG. 29 shows an embodiment that might be used to cover a long expanse, such as maybe a long pavilion, or a newer type of Jeep Wrangler that has a rear passenger section. It also could cover other vehicles like the Polaris UTV 4 seat vehicle and others. It is nice because the driver can tighten a single tightening location, and the force will instantly radiate through above the front passengers and the rear passengers, instantly tightening the soft material 5. In this embodiment the interconnecting mesh 16 has many connecting members 46 and connecting locations 18. It demonstrates that in all embodiments there can be an unlimited number of connecting members 46 and connecting locations 18. The tightener is a strap adjuster 140. The tightener can be anything used to tighten such as a ladderlock buckle, chord tightener, rope tightener, strap tightener, or any type of material tightener, etc.

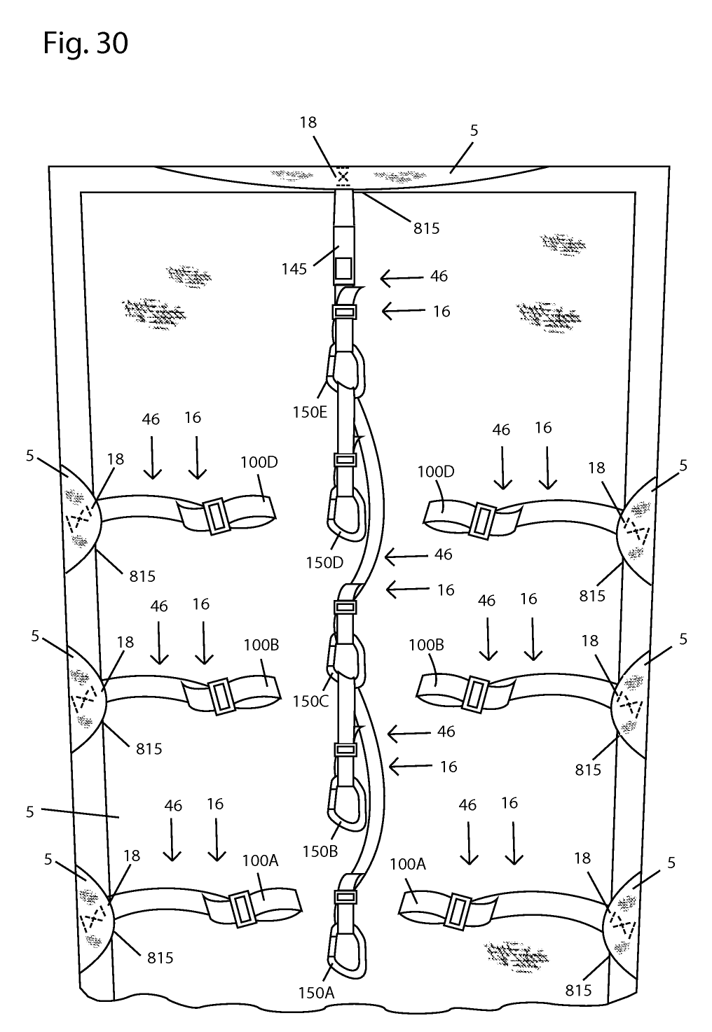

FIG. 30 shows just one example of the infinite interconnecting mesh and member combinations that are possible. Here carabineer 105A will connect to both loops 100A. Carabineer 150B will connect to both loops 100B. Carabineer 150C connects to the member that has carabineer 150A and 150B at each end. This member slides through carabineer 150C. Carabineer 150C is attached to one end of a member that has carabineer 150D at the other end. Carabineer 150D will connect to both loops 100D. Carabineer 150E connects to the member that has both carabineer 150D and 150C at each end. The member slides through carabineer 150E. The tightener, in this case a metal ratchet 145, is attached to the interconnecting mesh 16. It can be attached anywhere in the interconnecting mesh 16. Due to the interconnectedness of the interconnecting mesh, a single pull on the tightener simultaneously radiates a force throughout all connecting locations, in this case 7, and into the soft material. Most of the connecting locations will pull at an angle, both to the side and back, while the front is held in place and the rear is also stretched, effectively pulling the soft material in 8 directions simultaneously, thoroughly pulling out the slack in the soft material. An infinite number of members and carabineers and loops can be interconnected. This is just one demonstration of showing how a huge expanse can be covered very efficiently and effectively. The sliding effect of the members, provides a very nice advantage in that the force will easily redistribute itself to any location in the top that is not as tight as other areas of the soft material. This helps to provide an even distribution of force throughout the entire soft material. There is a multitude of other ways these members can be interconnected. In addition the members do not have to be divided. One example would be instead of the two separate members that both have loop 100A, instead a single member could be attached to one side of the soft material 5 and run straight through carabineer 150A and attach to the other side of the soft material 5. I could be made of any material.

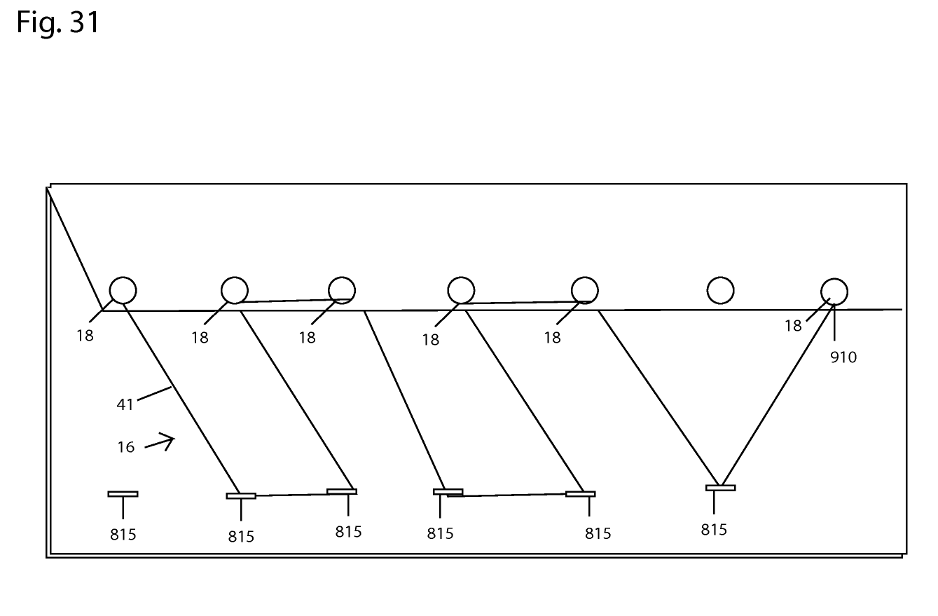

FIG. 31 is a side view of an embodiment that is covering an item, such as maybe the top of a long cargo truck. This image demonstrates that in all embodiments, there can be multiple wrapping locations 815, and multiple connecting locations 18, which in this case are eyelets, but can be anything. Because this is just a side view, at Exit Location 910 has been added to show where a single connecting member 41 that is part of the interconnecting mesh 16, leaves the view to go out of view and interconnect with the other connecting members that we cannot see in this view. In most embodiments, including this one, in most of the locations where there is a connecting location 18 or a wrapping location 815, the first connecting member 41 can slide along and does not have to be permanently attached or fixed. In this case the member does not slide through the eyelet on the far left, but slides through all of the other eyelets. So in this case a single member of the interconnecting mesh 16 weaves in and out of the connecting locations, in this case eyelets while wrapping around multiple wrapping locations, in this case pleats. But the pleats could be anything that allows something to wrap around.

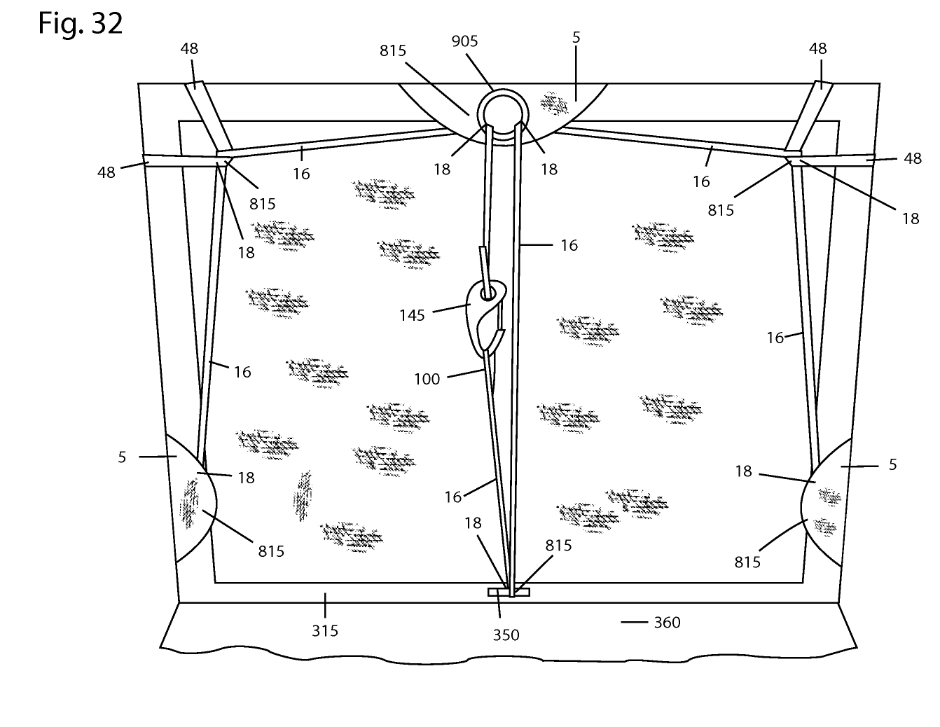

FIG. 32 is a view from below looking straight up at the soft material 5 in the operable position. This example is mostly to show the potential unlimited ways that the interconnecting mesh 16 can be made, interconnected unto itself, and connected to the soft material 5. In this example the interconnecting mesh 16 is made of cord. There is a loop 100 at one end of the interconnecting member 16 that was wrapped around a wrapping location, which in this case is a footman loop 350. The tightener in this case is a cord tightener 148. The cord tightener 148 is clipped to the loop 100. The interconnecting mesh 16 runs through a wrapping location, in this case a ring 905, and the interconnecting mesh also runs through straps prior art corner straps 48, which behave as wrapping locations, and the pliable planer material is attached the left and right forward sides of the soft planer material. In this example the tightening location is reduced to 1 location, the cord tightener 148, wherein the prior art this pliable planer material used 7 tightening locations. And the result under the prior art was dismal, in that the water would collect unless a rigid bow was added, and the top would have vibrated very loudly in the wind.

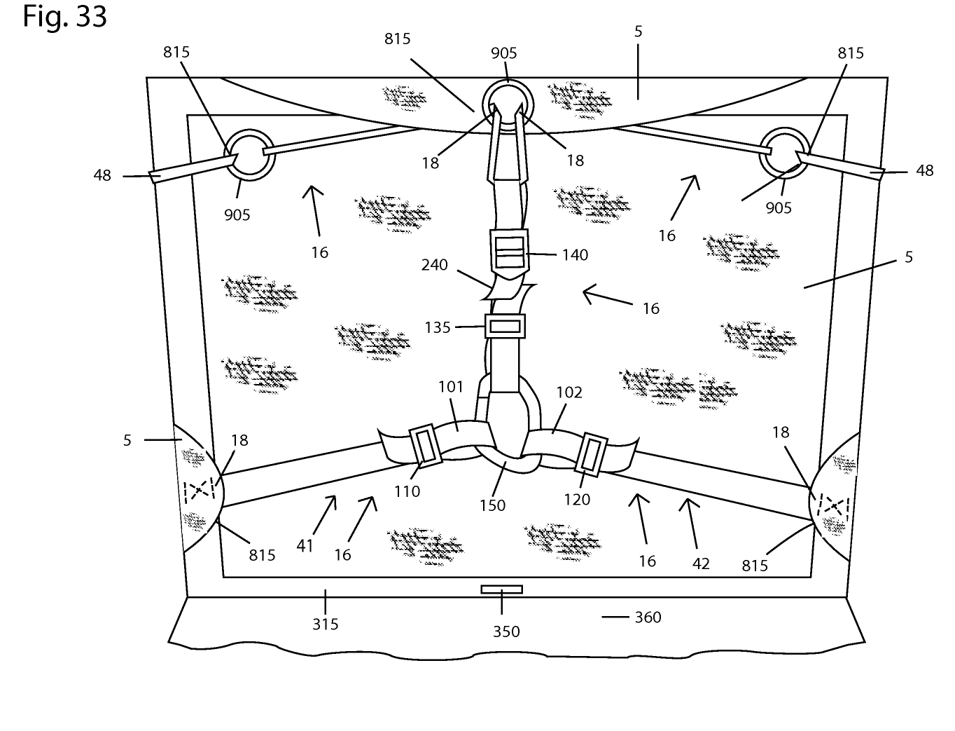

FIG. 33 is a view from below looking straight up at the soft material 5 in the operable position. This example is mostly to show the potential unlimited ways that the interconnecting mesh 16 can be made, interconnected unto itself, and connected to the soft material 5. The interconnecting mesh 16 is made of both strap and cord. The sides of the pliable planer material 5 are attached in a similar way as in a previous example. However, a cord then interconnects into the strap and runs through a wrapping location, in this case a ring 905 and it then goes on to interconnect with two more rings 905 towards the left and right sides of the soft material 5. The prior art corner straps 48 then connect to the ring 905 thereby attaching to and securing additional locations of the soft material 5. In this example the tightening location is reduced to 1 location, the strap adjuster 140; whereas, in the prior art this soft material 5 used 7 tightening locations. Though the new innovation reduces tightening and securing locations it functions far superior than the prior art, as no rigid support bows are needed to keep the rain off, and the top is quiet as it does not flap violently.

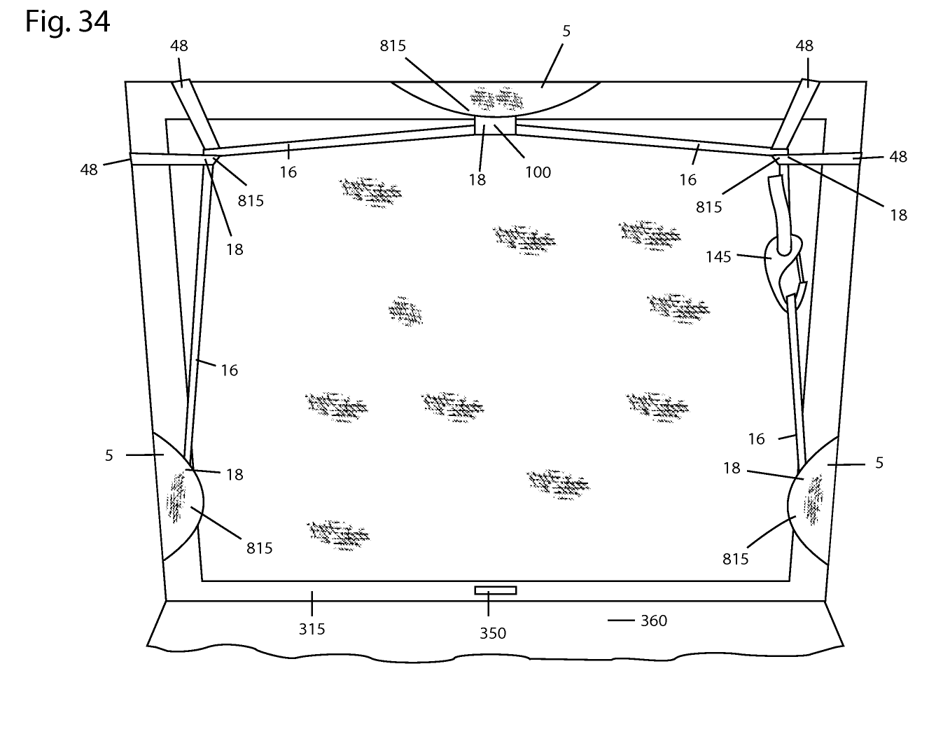

FIG. 34 shows that the interconnecting mesh 16 can even be of many different materials. In this case cord. Also, the interconnecting mesh 16 can be considered a single member, or two members, each brought together by the cord tightener 148. In this example a loop 100 is attached to the back of the pliable planer material. When the cord tightener is tightened, it simultaneously radiates through to all connection locations, including the rear corners, which in this example have been interconnected with the interconnecting mesh.

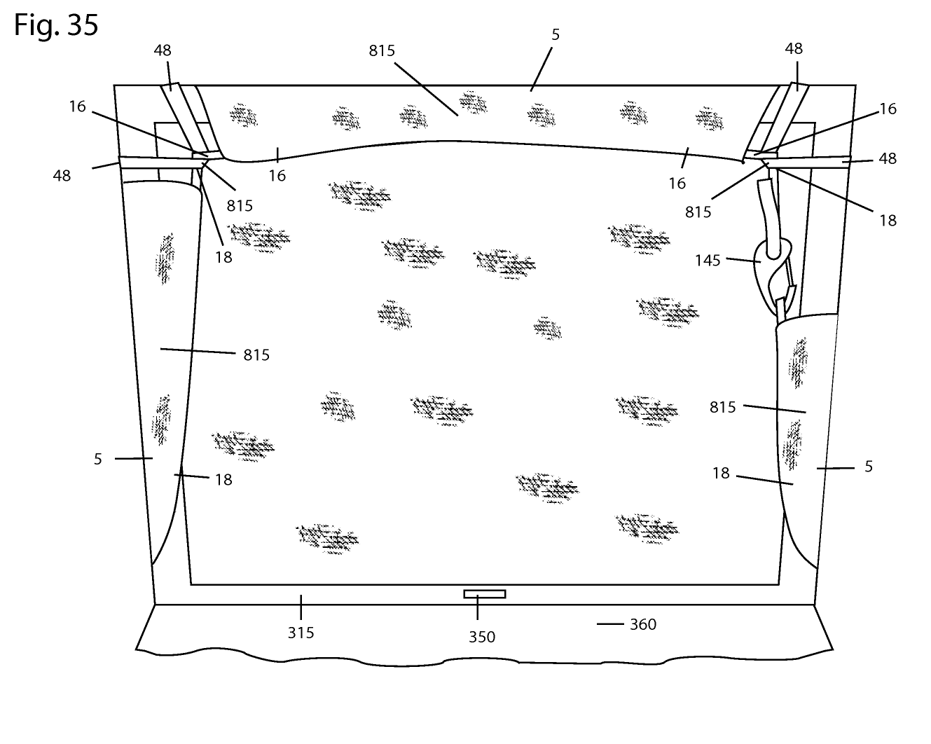

FIG. 35 is the same design as FIG. 35 with a few modifications. The wrapping locations are built into the top itself and are quite long compared to those in the previous figures. The interconnecting mesh 16 is made of cord. Most of the cord cannot be seen as the longer wrapping locations are serving two functions; one is to allow the interconnecting mesh 16 to slide through it; the other is to help conceal the interconnecting mesh. Concealing it can serve several nice purposes, including making it more appealable to the eye, and also keeping it confined, which can help to prevent it from becoming tangled. This also helps to demonstrate that the wrapping locations could be considered several different ways. In one regard the wrapping locations could be considered to be the solid support bars. In another regard the wrapping locations could be considered to be where the interconnecting mesh wraps through the fabric of the soft top. And it could also be considered that both the solid support bars of the vehicle and the location where the interconnecting mesh wraps through the soft top are both considered the wrapping locations.

### Other Alternative Embodiments and Considerations

### Change in the Angle of Pull

There is a great benefit in the change in angle on the soft material over that of the prior art. In the prior art, the pulling force pulled straight laterally. And in another location the force pulled straight back. In this innovation, several locations on the interconnecting mesh 16 pull in a diagonal direction. This causes the tensioning in the pliable planar material to simultaneously pull the soft material in both a rearward and transverse direction at the same time. This is a nice benefit and unexpected result that occurred when experimenting with interconnecting the side interconnecting members with the rear strap, which before hand has now example in the prior art of having been tested.

### Shapes of the Material

The shapes of the material that are secured and, or, tensioned can be of any formation. For example, the shape may be circular, rectangular, triangular, a polygon, not a polygon, etc. The material can recede inwards with an inward cut. All shapes can be secured with this device and method.

### Material Consistency

The device and method of tensioning and securing a material also works with rigid materials. Sometimes rigid materials also need to be tensioned. And sometimes, rigid materials don't need to be tensioned, but sometimes they need to be attached or secured in a very excellent way. For example, hard-shelled tents and construction projects sometimes need to go up quickly and be secured efficiently and tightly. So the device and method can be used on all materials, including but not limited to fabric, plastic, metal, wood, semi rigid materials, soft materials, mesh materials, etc.

### Mesh

There can be more than one mesh and locations. The mesh can be permanently connected, or they can be non-permanently connected. The interconnecting mesh can have a single member or multiple members. A member can interconnect other members and slide through them and have a single tightener attached to that member that slides through the other members, or the tightener can be on the other members, or there can be a tightener on both. There can also be multiple tighteners on the same member. The tightener can be partially located on the soft material or another object and partially on a member. The mesh can be interconnected in infinite ways. The mesh can include corner members, side members, center members that attach in any locations on the soft material. When rings are referenced, they don't have to be rings. They can be anything that allow the interconnecting mesh to slide through some examples might be ropes, straps, etc. And when rings are used they can be made out of any material. In one example a metal ring was used, but it could be plastic, polymer, or any material. The mesh can be connected so that at some locations there is no sliding motion. The mesh can touch the wrapping location, or it may not touch the wrapping location, as the soft material may touch the wrapping location, due to the force of the mesh pulling it around the wrapping location.

### Attachment Locaions & Members

All other sides and corners and other places on the material can all be brought in with connecting members and combined in the mesh. The connections do not have to be on the edges, but can be more towards the center of the material as well. The mesh can have unlimited numbers of connections between the members. The basic underlying principal still remains the same. And that is, that under the prior art the material could not be secured well. In some situations, the attachment locations will be in the center of the material. One of many examples would be a rear connecting member, many times might be somewhat centrally located compared to side members, and if the soft material is long, it could put it forward of center, in center, or rearward of center on the soft material. In some situations, just two sides will have connections, and the wrapping member or members will connect in two locations, but wrap around three wrapping locations.

### Connecting Members

There are many different ways to form the first connecting member, the second connecting member, the third connecting member, and any additional connecting members.

### Tightening the Mesh

There can be more than one device for tightening the mesh. The tightening device can be of many different types and designs and located on any of the connecting members. The tightener can be any type of tightener. In one situation it is a ladderlock buckle. In another case it is a chord tightener. But it can be other types and any type of tightener. The tightener could pull tight, ratchet tight, spin tight, or could tighten any other type of way. The type of material or members may determine the type of tightener. The type of tightener is not limited to what is disclosed here or in the drawings as those practiced in the art will come up with many tighteners, and new tighteners will be developed in the future. They all can be used in this innovation.

### Interconnecting the Mesh & Attaching Locations

All connections and interconnections in all of the embodiments can be fixed or sliding or can be formed in any other manner. There are many ways that experts in the field know how to make connections and interconnections. All of them can be used, including but not limited to binding, clamping, gluing, stapling, using a hook, using a loop, using a not, tying, riveting, sewing, interweaving, wrapping, etc.

### Uses

Some of the examples above showed support structures for bikini top soft tops, but it works on tops, sides, bottoms, and all shapes and types of materials. The industries and uses include but are not limited to vehicle passenger compartment tops, pickup truck tonneau covers, cargo truck tops, tent tops and sides, Bimini tops for boats, and just about any application and industry where a material needs to be tensioned and, or, secured. It also works with all forms of material such as soft, rigid, semi rigid, rigid, etc. The mesh can be of all forms of material as well such as soft, rigid, semi rigid, rigid, etc. More members can be used for longer expanses. One example is vehicles that cover both forward and rearward passenger compartments, etc.

### In Addition

While the foregoing written description enables one of ordinary skill to make and use what is considered presently to be the best mode thereof, those of ordinary skill will understand and appreciate the existence of variations, combinations, and equivalents of the specific embodiment, method, and examples herein.

I claim:

1. A securing and tensioning system, comprising:
a soft material;
an interconnecting mesh comprising at least a first member, and said interconnecting mesh having at least three connecting locations attached to said soft material in generally three dispersed locations;
at least one tightener attached to at least one spot on said interconnecting mesh, wherein tightening said tightener causes said soft material to be simultaneously stretched and tensioned in at least three different directions as said soft material is guided towards at least three dispersed wrapping locations;
whereby the number of connecting and tightening locations are reduced, yet no rigid bow is needed to keep water from collecting in puddles on the soft material, and the noise is almost completely eliminated when driving at high speeds.

2. The securing and tensioning system of claim 1, wherein said soft material includes at least one section that is attached to a structure.

3. The securing and tensioning system of claim 1, wherein said soft material includes rear corner connectors.

4. The securing and tensioning system of claim 1, wherein at least one of said at least three connecting locations is a sliding attachment.

5. The securing and tensioning system of claim 1, wherein said at least one member includes at least one sliding member that is attached to said interconnecting mesh.

6. The securing and tensioning system of claim 1, wherein said at least one member includes at least one sliding member that has at least a first section that either on its own or through its interconnectedness to said interconnecting mesh radiates out and connects in at least two locations on said soft material, and said sliding member has at least a second section that either on its own or through its interconnectedness to said interconnecting mesh radiates out and connects in at least two additional locations on said soft material, and said sliding member is connected between said at least first section and said at least second section to said interconnecting mesh by a sliding attachment.

7. The securing and tensioning system of claim 1, wherein said soft material has at least a left side, a right side, a front side, and a rear side, wherein said front side is attached to a structure, wherein said interconnecting mesh comprises at least a first connecting member, at least a second connecting member, and at least a third connecting member that are interconnected unto themselves, and at the end of said first connecting member is at least one of said at least three connecting locations and is attached to said left side, at the end of said second connecting member is at least one of said at least three connecting locations and is attached to said right side, at the end of said third connecting member is at least one of said at least three connecting locations and is connected to said soft material generally between and rearward of said left side and said right side.

8. A securing and tensioning system, comprising:
an interconnecting mesh comprising at least a first member, and said interconnecting mesh having at least three connecting locations for attaching to a soft material in generally three dispersed locations;
at least one tightener attached to at least one spot on said interconnecting mesh, wherein tightening said tightener causes said soft material to be simultaneously stretched and tensioned in at least three different directions as said soft material is guided towards at least three dispersed wrapping locations;
whereby the number of connecting and tightening locations are reduced, yet no rigid bow is needed to keep water from collecting in puddles on the soft material, and the noise is almost completely eliminated when driving at high speeds.

9. The securing and tensioning system of claim 8, wherein said interconnecting mesh includes rear corner connectors.

10. The securing and tensioning system of claim 8, wherein at least one of said at least three connecting locations is a sliding attachment.

11. The securing and tensioning system of claim 8, wherein said at least one member includes at least one sliding member that is attached to said interconnecting mesh.

12. The securing and tensioning system of claim 8, wherein said at least one member includes at least one sliding member that has at least a first section that either on its own or through its interconnectedness to said interconnecting mesh radiates out and connects in at least two locations on said soft material, and said sliding member has at least a second section that either on its own or through its interconnectedness to said interconnecting mesh radiates out and connects in at least two additional locations on said soft material, and said sliding member is connected between said at least first section and said at least second section to said interconnecting mesh by a sliding attachment.

13. A method for securing and tensioning a soft material, comprising:
providing a soft material;
providing an interconnecting mesh comprising at least one member, and said interconnecting mesh having at least three connecting locations;
connecting said at least three connecting locations to generally three dispersed locations on said soft material around at least three dispersed wrapping locations;
providing at least one tightener;
attaching said tightener to at least one spot on said interconnecting mesh;
tightening said tightener, wherein said soft material is simultaneously stretched and tensioned in at least three different directions as said soft material is guided towards said at least three dispersed wrapping locations;
whereby the number of connecting and tightening locations are reduced, yet no rigid bow is needed to keep water from collecting in puddles on the soft material, and the noise is almost completely eliminated when driving at high speeds.

14. The method for securing and tensioning a soft material of claim 13, wherein said interconnecting mesh includes rear corner connectors.

15. The method for securing and tensioning a soft material of claim 13, wherein at least one of said at least three connecting locations is a sliding attachment.

16. The method for securing and tensioning a soft material of claim 13, wherein said at least one member includes at least one sliding member and attaching it to said interconnecting mesh.

17. The securing and tensioning system of claim 13, wherein said at least one member includes at least one sliding member that has at least a first section and at least a second section;
attaching said first section to at least two lateral locations on said soft material;
attaching said second section to at least two lateral locations on said soft material;
providing a rearward attaching member that has at least a first end and at least a second end;
attaching said at least first end to generally a location on said soft material that is central and rearward of said at least two lateral locations;
attaching said at least second end to said at least one sliding member between said at least first section and at least second section by a sliding attachment.
